(19) United States
(12) Patent Application Publication
(10) Pub. No.: US 2021/0267835 A1
(43) Pub. Date: Sep. 2, 2021

(54) SACROILIAC JOINT MOBILIZATION DEVICE AND METHODS OF USE THEREOF

(71) Applicant: DPT Tools LLC, Louisville, CO (US)

(72) Inventor: Chris DeGrandis, Louisville, CO (US)

(21) Appl. No.: 16/806,233

(22) Filed: Mar. 2, 2020

(51) Int. Cl. A61H 1/02; A61H 1/00

(52) U.S. Cl. CPC A61H 1/0244; A61H 1/008; A61H 2203/0456; A61H 2201/168; A61H 2201/1628

(57) ABSTRACT

The present invention includes a device for localized joint mobilization in the pelvic area, and in particular, it relates to a novel sacroiliac mobilizing device and improved methods for mobilizing and establishing efficient mechanical alignment of the sacroiliac joint that may be accomplished by a subject in need thereof with, or without professional medical assistance.

### TECHNICAL FIELD

The present invention relates to a device and a method for mobilizing and establishing efficient mechanical alignment of the sacroiliac joint during physical therapy and as part of an ongoing program of self-care and maintenance.

### BACKGROUND

The sacroiliac joint (SI joint or SIJ) is the joint between the sacrum and the ilium of the pelvis. The SIJ is a paired joint where the sacrum, a triangular shaped bone at the base of the spine, meets each side of the pelvis. The pelvis consists of three bones (ilium, ischium, and pubis) that fuse during childhood and adolescence, with the SIJ being positioned where the sacrum articulates with the ilium of the pelvis. Importantly, the SIJs play an important role in stabilizing the “core” of the body. For example, the sacrum supports the spine and the pelvis is an extension of the legs. As a result, the SIJs are the place where the upper part of the human body meets the lower part of the human body, and as such are subject to a constant flow of forces from upper body to lower and vice versa, potentially contributing to core instability.

The SI joint is a synovial joint with opposing surfaces covered in articular cartilage, and irregular elevations and depressions that produce an interlocking of the two bones. Since the SIJ is a large, irregular, and complex joint, even small shifts in alignment at this integral junction between upper body and lower can contribute to decreased range of motion, decreased functional mobility, and pain, not only in the joint itself, but in surrounding tissues. As a result, it is essential to maintain optimal SIJ alignment and mobility. Indeed, a significant portion of low back pain can be attributed to SIJ dysfunction, with pain at times referring into the buttock and legs. SI joints also contribute to pelvic dysfunction that can, in turn, result in complications in childbirth, bladder and other pelvic disorders, such as uterine and colon pain. SI joint pain and dysfunction limit the motion of the pelvis in sitting, standing, and walking further aggravating low back pain. In addition to the day-to-day instability associated with forces passing through SIJs from upper body to lower, SIJ dysfunction can be caused by more severe conditions including traumatic impact, osteoarthritis, various inflammatory processes, or other degenerative conditions of the SI joint.

Non-invasive treatment of SI joint dysfunction and pain is typically accomplished through manual physical therapy. As such, there exists a long-felt need for devices specifically designed to allow patients to mobilize SI joints during physical therapy and as part of an ongoing program of self-care and maintenance designed to extend the life of manual physical therapy care provided in the clinic.

### SUMMARY OF THE INVENTION

In one preferred aspect, the invention includes a device for mobilizing a SI joint in a subject in need thereof. In one preferred aspect, a subject in need may use the invention's SI joint mobilizing device in a clinical setting, for example during physical therapy, or in a home setting where a subject may employ the device to mobilize their SI joint as needed, or as part of a prescribed therapeutic regime.

The SIJ mobilization device of the invention may be used as a fulcrum that, when applied to a subject's SIJ complex (sacrum, pelvis, and associated SIJs), allows for the mobilization of the SI joint. For example, a subject may be placed in a generally supine position, and preferably on a rigid surface, such as a floor. In this position, SIJ mobilization device of the invention may be positioned within the subject's SIJ complex such that the weight of the subject's pelvic complex (pelvis, sacrum, coccyx, hips, and lower lumbar spine and abdominal contents) may press downwardly further securing the SIJ mobilization device within the subject's SIJ complex.

Next, a user may initiate one, or a series of prescribed movements that cause the SIJ mobilization device of the invention to mobilize the subject's SI joint. In an alternative aspect, a user may position the SIJ mobilization device of the invention as generally described above, and may, with the assistance of a care provider, such as a physical therapist or other medical professional, initiate one, or a series of movements as directed by the care provider that cause the SIJ mobilization device of the invention to mobilize the subject's SI joint. This SI joint mobilization procedure, whether self-initiated or assisted by a care provider may be performed on an as-needed basis to relieve SI joint pain, for example. Alternatively, a SI joint mobilization procedure, whether self-initiated or assisted by a care provider may be performed on a prescribed basis as part of an ongoing program of self-care and maintenance.

Notably, as generally detailed below, the configuration of the SI joint mobilization device, and its placement in relation to the subject's SIJ complex may, allow for mobilization of the patient's SI joint solely from the force generated by the weight of the subject's own pelvic complex pressing downwardly against the device causing the desired SI joint mobilization.

### BRIEF DESCRIPTION OF THE FIGURES

FIG. 1 shows a front perspective view of a SI joint mobilizing device of the invention in one embodiment thereof;

FIG. 2 shows a front view of a SI joint mobilizing device of the invention in one embodiment thereof;

FIG. 3 shows a back view of a SI joint mobilizing device of the invention in one embodiment thereof;

FIG. 4 shows a right side view of a SI joint mobilizing device of the invention in one embodiment thereof;

FIG. 5 shows a left side view of a SI joint mobilizing device of the invention in one embodiment thereof;

FIG. 6 shows a top view of a SI joint mobilizing device of the invention in one embodiment thereof;

FIG. 7 shows a bottom view of a SI joint mobilizing device of the invention in one embodiment thereof;

FIG. 8 shows a front perspective view of a SI joint mobilizing device of the invention in one embodiment thereof;

FIG. 9 shows a front view of a SI joint mobilizing device of the invention in one embodiment thereof;

FIG. 10 shows a back view of a SI joint mobilizing device of the invention in one embodiment thereof;

FIG. 11 shows a right side view of a SI joint mobilizing device of the invention in one embodiment thereof;

FIG. 12 shows a left side view of a SI joint mobilizing device of the invention in one embodiment thereof;

FIG. 13 shows a top view of a SI joint mobilizing device of the invention in one embodiment thereof;

FIG. 14 shows a bottom view of a SI joint mobilizing device of the invention in one embodiment thereof;

FIG. 15 shows a front perspective view of a SI joint mobilizing device of the invention in one embodiment thereof;

FIG. 16 shows a front view of a SI joint mobilizing device of the invention in one embodiment thereof;

FIG. 17 shows a back view of a SI joint mobilizing device of the invention in one embodiment thereof;

FIG. 18 shows a right side view of a SI joint mobilizing device of the invention in one embodiment thereof;

FIG. 19 shows a left side view of a SI joint mobilizing device of the invention in one embodiment thereof;

FIG. 20 shows a top view of a SI joint mobilizing device of the invention in one embodiment thereof;

FIG. 21 shows a bottom view of a SI joint mobilizing device of the invention in one embodiment thereof; and

FIG. 22: SIJ mobilization device (1) positioned over an exemplary sacrum with the opposing longitudinal extensions (4) positioned between the two Posterior Superior Iliac Spines (PSISs) of the pelvis in one embodiment thereof.

### DETAILED DESCRIPTION OF THE INVENTION

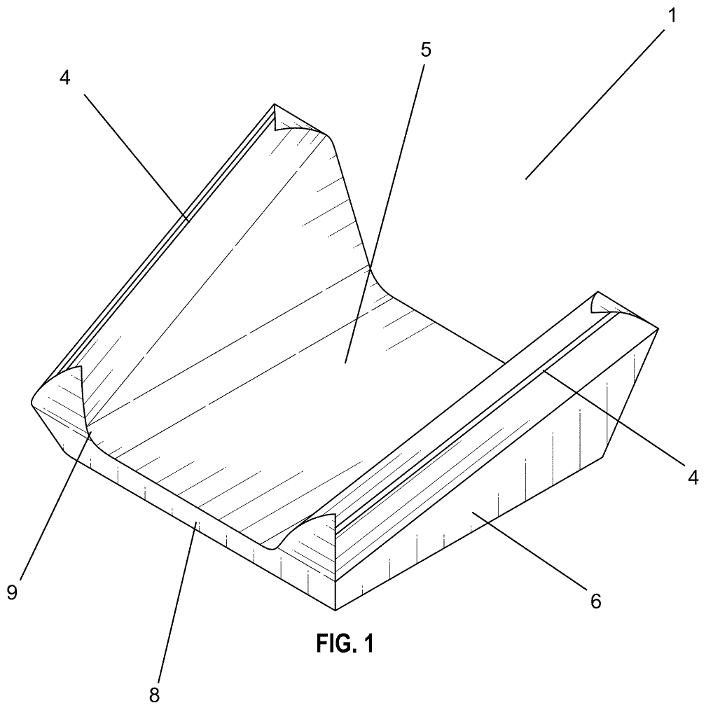

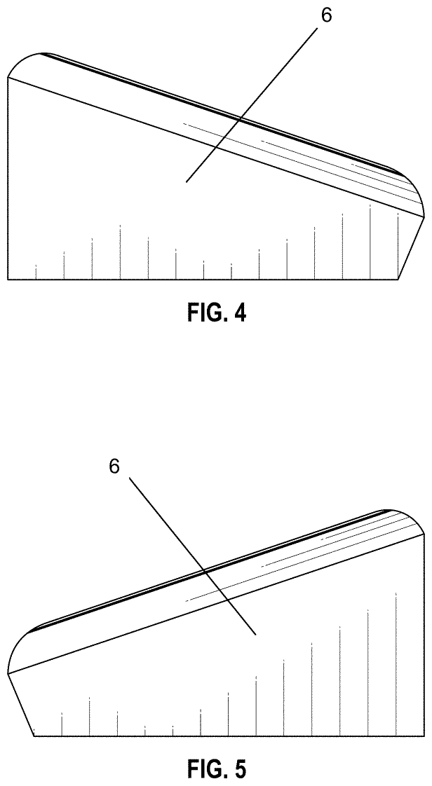

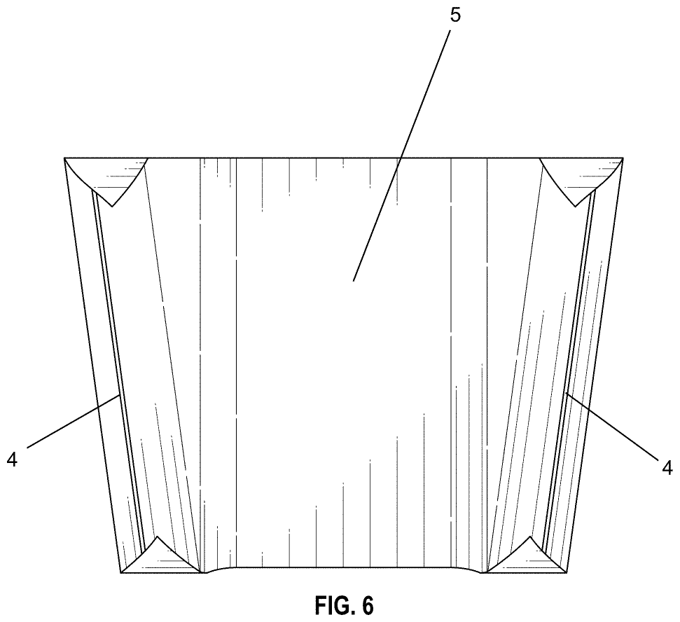

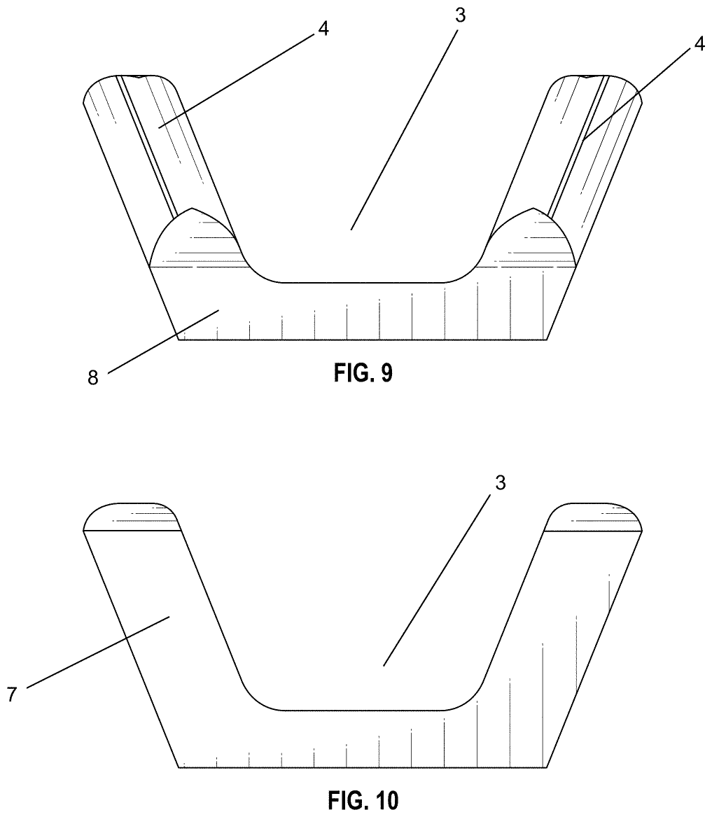

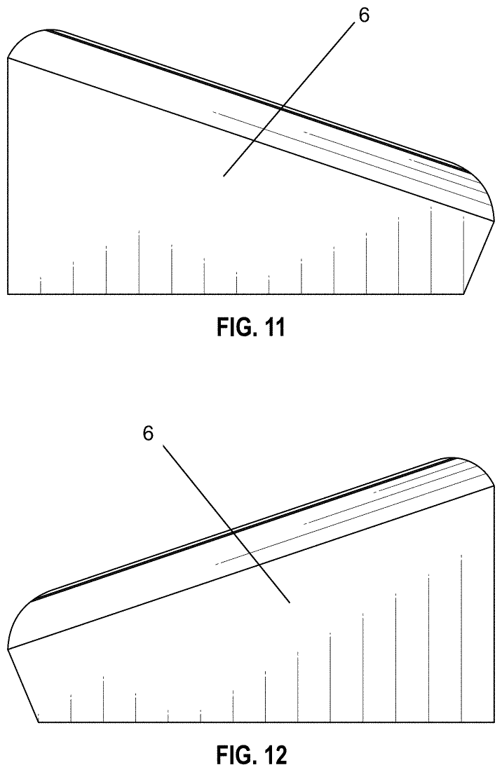

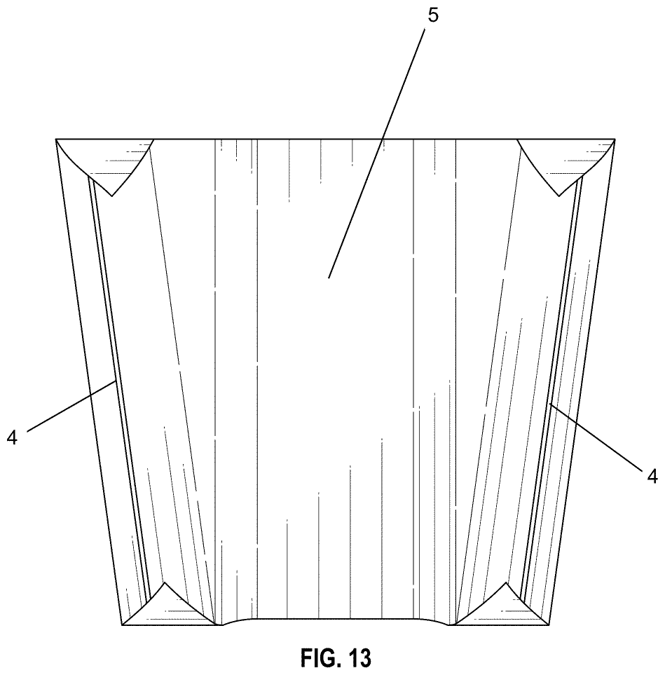

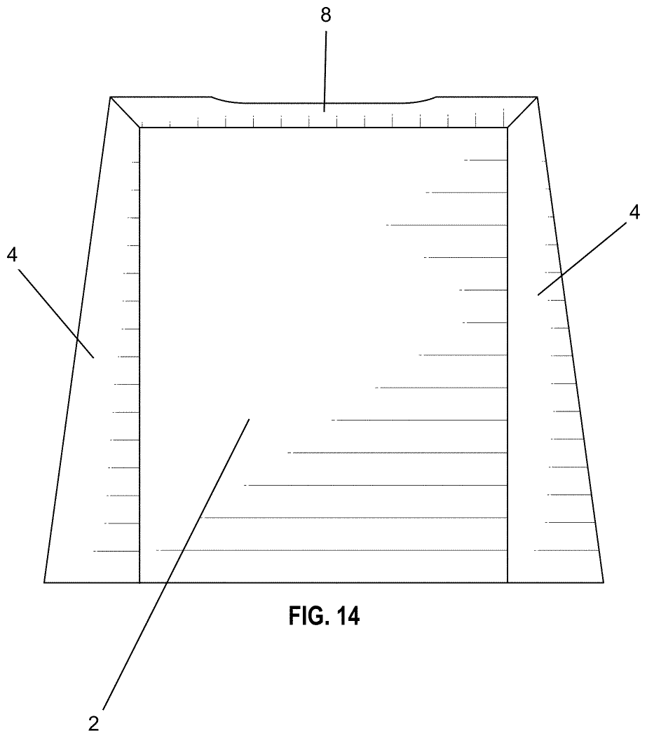

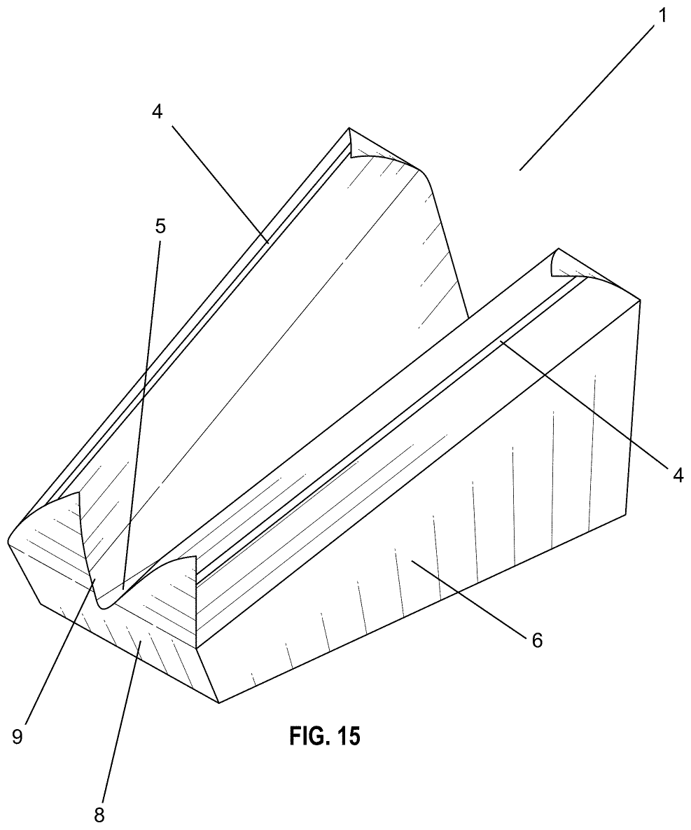

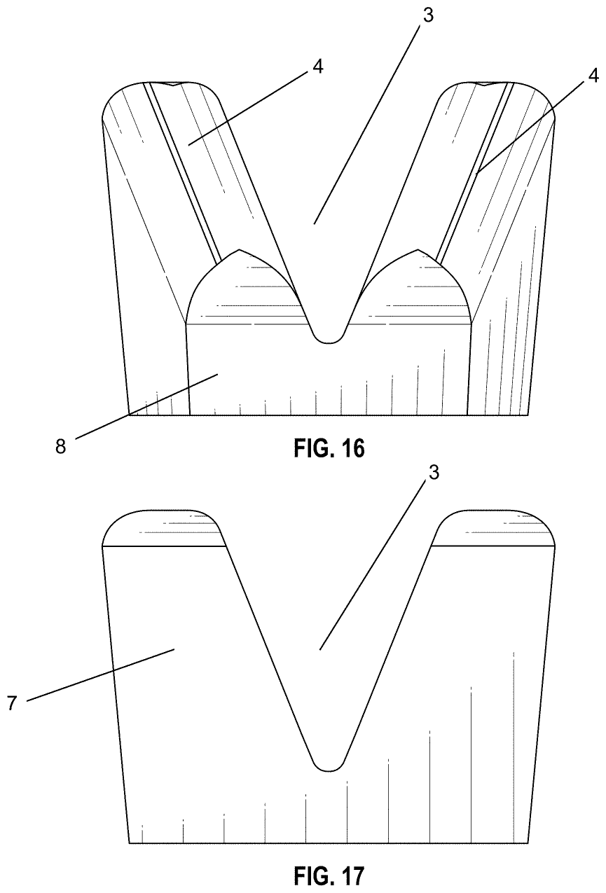

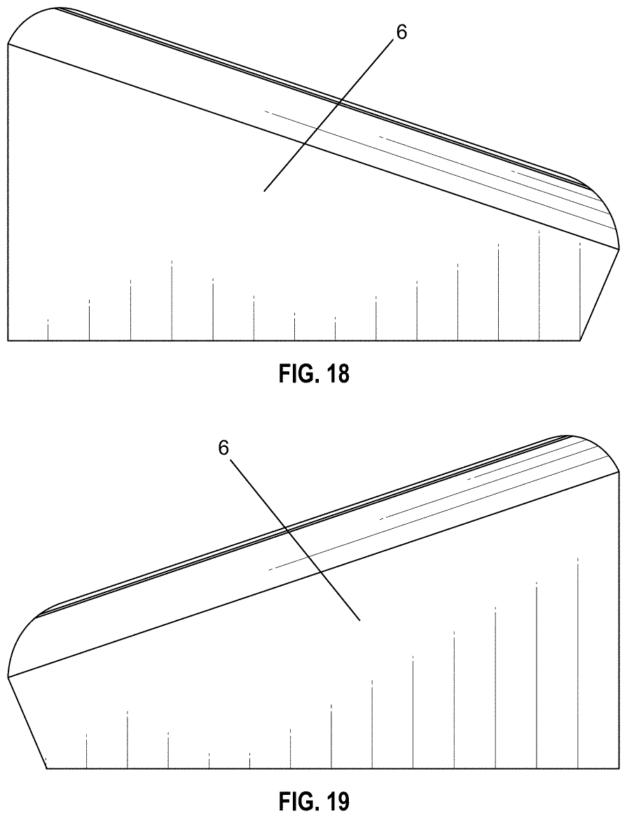

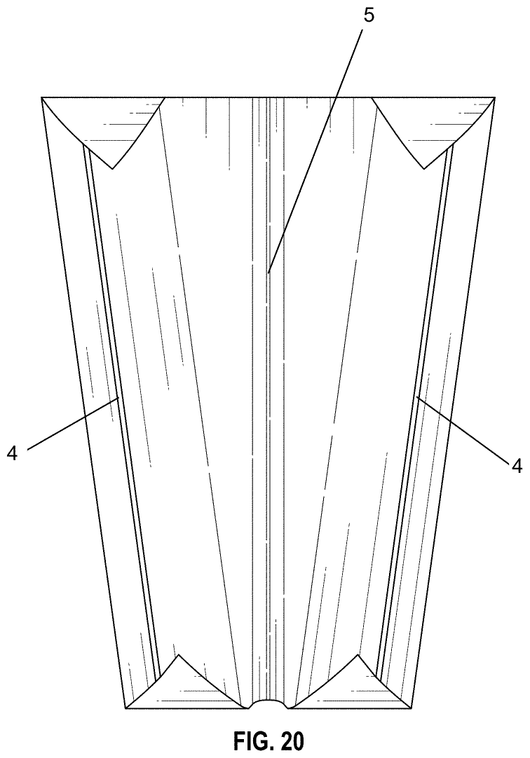

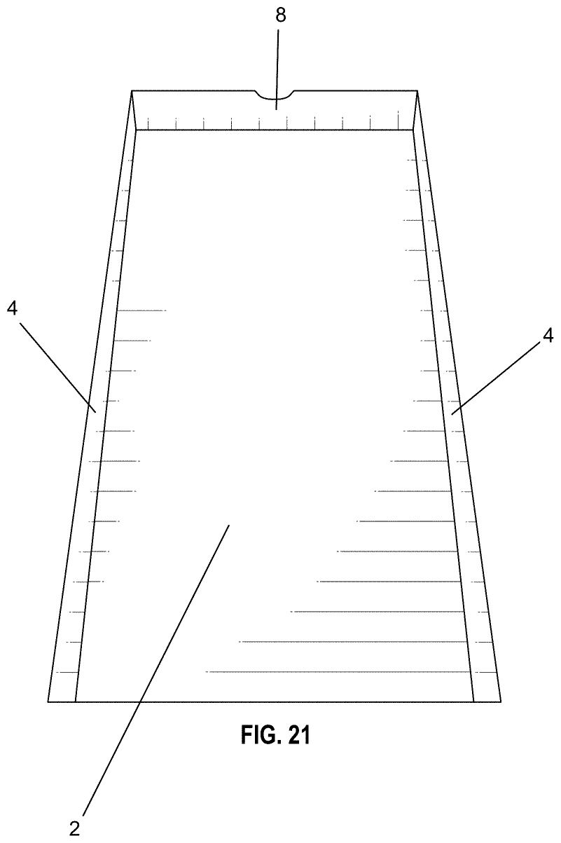

Generally referring to FIGS. 1-21, the invention may include a SIJ mobilization device (1) according to an exemplary embodiment of the present invention is shown. The SIJ mobilization device (1) of FIGS. 1-7 may be formed of one or more tractably rigid materials, such a plastic, thermoplastic, rubber, silicone, silicone rubber, other composite materials, and the like. In this preferred embodiment, the SIJ mobilization device (1) of the invention may be configured to be coupled with the SIJ complex of a subject. Notably, different embodiments of the SIJ mobilization device (1) of the invention may be configured to accommodate the anatomical variances that may exist within the biometrics of SIJ complexes, for example, variances in distance from one Posterior Superior Iliac Spine (PSIS) of the pelvis to the other.

For example, generally referring to FIGS. 1-7, the invention may include a SIJ mobilization device (1) that may be suitable for a subject with a distance from one PSIS to the other exceeding 3 inches in need thereof. The SIJ mobilization device (1) of FIGS. 1-7 includes a flat, planar base (2), that in an exemplary embodiment, may be approximately 2 inches wide, 1.5-2 inches long, and as described in more detail below, a plurality of angled longitudinal extensions (4) having a height of approximately 1 inch, and a sacral pocket of approximately 2 inches.

In another example, generally referring to FIGS. 8-14, the invention may include a SIJ mobilization device (1) that may be suitable for a subject with a distance from one PSIS to the other ranging from 2⅜-3 inches in need thereof. The SIJ mobilization device (1) of FIGS. 8-14 includes a flat, planar base (2), that in an exemplary embodiment, may be approximately 1.5 inches wide, 1.5-2 inches long, and as described in more detail below, a plurality of angled longitudinal extensions (4) having a height of approximately 1 inch, and a sacral pocket of less than 1.5 inches.

In another example, generally referring to FIGS. 15-21, the invention may include a SIJ mobilization device (1) that may be suitable for a subject with a distance from one PSIS to another less than 2⅜ inches in need thereof. The SI mobilization device (1) of FIGS. 15-21 includes a flat, planar base (2), that in an exemplary embodiment, may be between 1-1.5 inches wide, 1.5-2 inches long, and as described in more detail below, a plurality of angled longitudinal extensions (4) having a height of approximately 1 inch, and a substantially narrow sacral pocket (3).

Notably, the height of the different embodiments of the SIJ mobilization device (1), and in particular the angled longitudinal extensions (4), may be generally consistent at approximately 1 inch, allowing for the optimal anatomical configuration to be mated with the SIJ complex of the subject as detailed below.

In one preferred embodiment, the SIJ mobilization device (1) of the invention may include an approximately square planar base (2) that may be configured to be positioned on a flat surface, such as a floor, and further may include one or more non-slide features. For example, in one embodiment the planar base (2) may be formed of a rubberized material, such as silicone rubber, with a high coefficient of friction to prevent unwanted slipping on a flat surface. In additional embodiment, the planar base (2) may include additional frictional surfaces (not shown) that may include surface features, such as ridges that increase the coefficient of friction along the planar base (2).

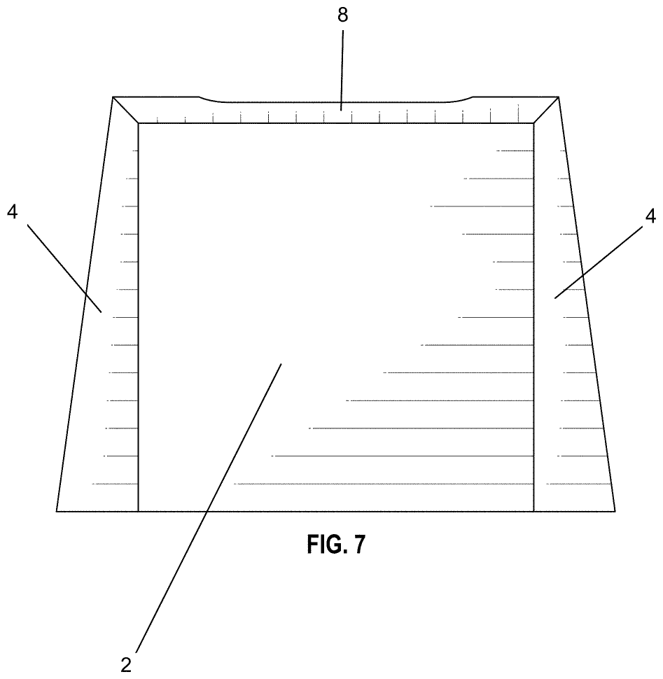

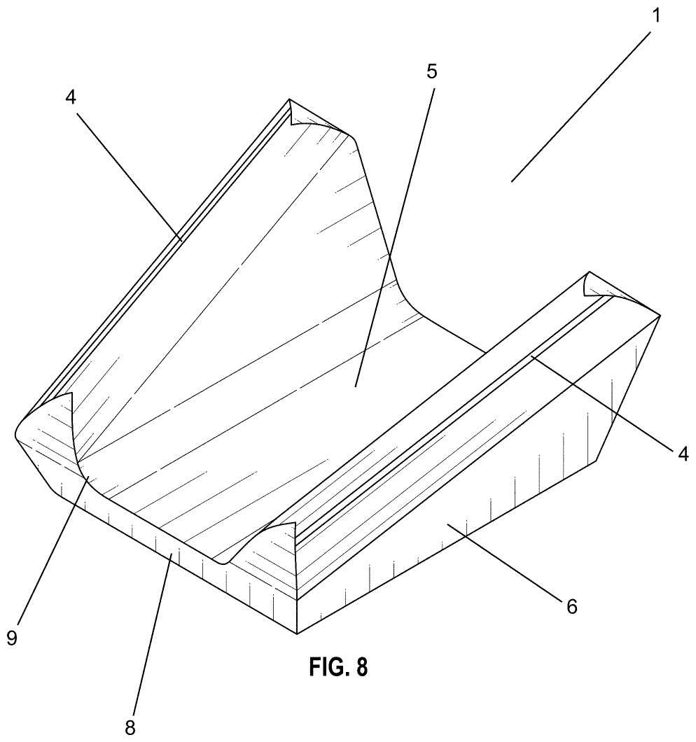

Again, referring to the embodiment of FIG. 1, the SIJ mobilization device (1) of the invention may include a pair of opposing longitudinal extensions (4) extending longitudinally from opposing sides of the planar base (2). As shown in the embodiment of FIG. 7, the opposing longitudinal extensions (4) extend laterally outward from the planar base (2) forming left and right side walls (6) respectively. As also shown in the embodiment of FIG. 7, the opposing longitudinal extensions (4) extend beyond the anterior end line of the planar base (2) forming an angled front wall (8). Again, as also shown in the embodiment of FIG. 7, the opposing longitudinal extensions (4) extend up to the posterior end line of the back of the planar base (2) forming a flattened back wall (7) surface.

In one preferred configuration, the longitudinal extensions (4) may be in an angled formation, such that the leading posterior edge of the opposing longitudinal extensions (4) are extended outwardly and decrease as the longitudinal extensions (4) are directed to the anterior portion of the SIJ mobilization device (1). In this configuration, the angled longitudinal extensions (4) form a pair of sloping longitudinal extensions (4) reflecting the average slope of a human sacrum that may allow the device to be mated to the sacral portion of a subject's SIJ complex while also providing the appropriate fulcrum to allow SI joint mobilization when interfaced with a subject's SIJ complex on a flat surface.

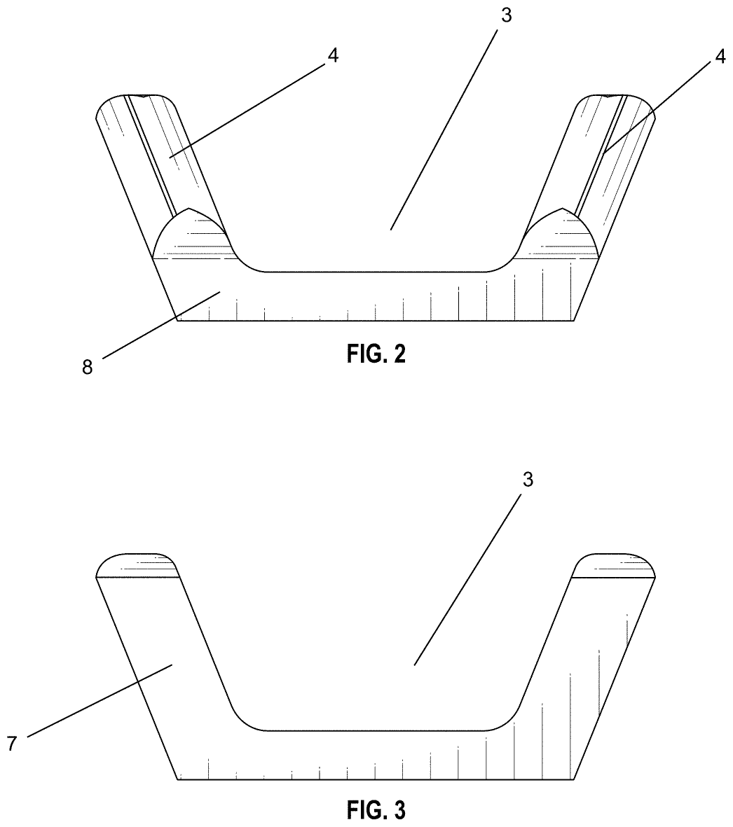

As generally shown in FIGS. 2, 9, and 16, the opposing longitudinal extensions (4) may extend outwardly from the planar base of the SIJ mobilization device (1), such that the interior edge of the opposing longitudinal extensions (4) are positioned at an angle between 20°-25° from a median center line drawn through the device. In a preferred embodiment, the opposing longitudinal extensions (4) extend outwardly from the planar base of the SIJ mobilization device (1) forming such that the interior edge of the opposing longitudinal extensions (4) are positioned at an angle of 22° degrees from a median center line drawn through the device reflecting the average angle of the pelvis as it articulates with the sacrum at the SIJ. As detailed below, in this embodiment, the optimal angle configuration may facilitate the coupling of the SIJ mobilization device (1) of the invention to the pelvic portion of a subject's SIJ complex and more easily facilitate SI joint mobilization, and in particular self-administered SI joint mobilization by a subject.

As shown generally in FIGS. 1 and 8, the opposing longitudinal extensions (4) in relation to the planar base (2) form a sacral pocket (3) along the interior position of the SI mobilization device (1) of the invention. As detailed below, this sacral pocket may include contact surface (5) that may come into physical contact with subject when placed over the sacrum. In this configuration, when force is applied to the contact surface (5) of the sacral pocket (3), such as the downward force supplied by the weight of a subject's own pelvic complex when the SIJ mobilization device (1) of the invention is positioned within the SIJ complex of a supine subject. In this embodiment, the opposing longitudinal extensions (4) may flex outward, for example along a tractable connection (9) between the planar base and longitudinal extensions (4) thereby allowing the SIJ mobilization device (1) to be positioned in a flush configuration in relation to the subject's sacrum. By maintaining this flush configuration, the SIJ mobilization device (1) of the invention allows for more effective SI joint mobilization in response to a series of movements that may be executed by said subject. In the embodiment shown in the figures, the tractable connection (9) may be formed by the interface between the longitudinal extension (4) in relation to the planar base (2) that may allow the longitudinal extension (4) to extend outwardly due to the tractable nature of the material used to produce the device. In another embodiment, a tractable connection (9) may include an adjustable connection that may further include a locking mechanism such that the angle and position of a longitudinal extension (4) in relation to the planar base (2) may be adjusted per a subject's preference. In this configuration, the contact surface (5) of the sacral pocket (3) may be adjusted to accommodate a user's preference or unique anatomy.

Additional embodiments of the invention may include methods of mobilizing a SI joint, and preferably of mobilizing a SI joint utilizing the SI mobilization device of the present invention.

In one preferred embodiment of use, a subject, or care provider/medical professional, may first locate the subject's right and left posterior superior iliac spines (PSISs). PSISs are bony prominences at the back of the pelvis located about 1 to 1½ inches from midline, or about 2 to 3 inches apart from one another. PSISs are positioned superficially and can generally be palpated through the skin over the SIJ complex.

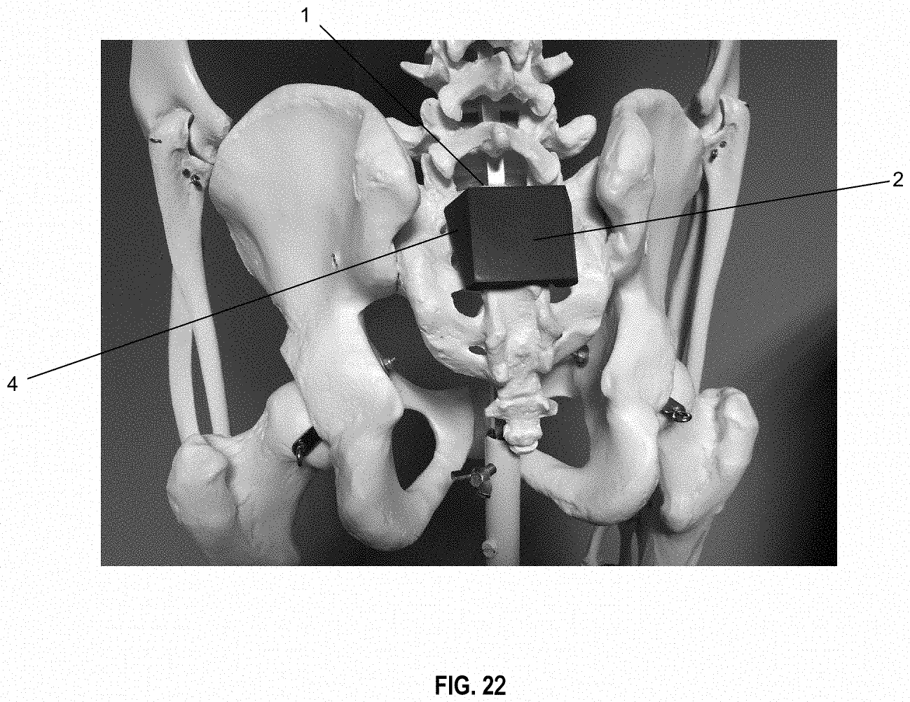

Next, as generally shown in FIG. 22, a subject, or care provider/medical professional, may place a SIJ mobilization device (1) of the invention within the SIJ complex. In the preferred embodiment shown below, the posterior surface of the opposing longitudinal extensions (4) of the SIJ mobilization device (1) may be positioned in between the two PSISs. In this position, the opposing longitudinal extensions (4) of the SIJ mobilization device (1) may be in contact with the subject's body and the bottom surface of the planar base (2) facing outward. Notably, the posterior, or taller end of the longitudinal extensions (4) should be positioned so as to be directed towards the subject's head, while the anterior, or shorter end of the longitudinal extensions (4) should be positioned towards the subject's feet. As shown below, in this embodiment, the angled longitudinal extensions (4) may more easily conform to the natural sloping configuration of the human sacrum. Notably, the positioning of the SI mobilization device (1) can either be done directly on the subject's skin or through light layers of clothing.

Next, a subject may assume a supine position while securing the SIJ mobilization device (1) within their SIJ complex, assuming they were not already in a supine position prior to this step. In this embodiment, the planar base (2) of the SIJ mobilization device (1) may be resting on a hard surface, such as a floor. Once in this supine position with the SIJ mobilization device (1) coupled with the subject's SIJ complex, the subject may bend their knees bringing the bottoms of their feet into a resting position on the hard surface. A subject may optionally relax their pelvic and abdominal muscles, allowing the weight of the subject's pelvic complex to settle onto the SIJ mobilization device (1), and further allowing the longitudinal extensions (4) to sink into the SI joints so as to more securely couple with subject's SIJ complex in the sacral pocket (3) of the device.

Next, a subject alone, or with the assistance of a care provider/medical professional, may engage in one, or a series of prescribed motions to allow mobilization of the subject's SI joint. In one preferred embodiment, a subject alone, or with the assistance of a care provider/medical professional, may initiate one, or a series of controlled back-and-forth movements of the subject's knees allowing the SIJ mobilization device (1) of the invention to mobilize the pelvic portion of the SIJ complex on the sacrum at the SIJ. In another preferred embodiment, a subject alone, or with the assistance of a care provider/medical professional, may initiate one, or a series of controlled pelvic tilts towards the subject's head followed by one, or a series of controlled pelvic tilts towards the subject's feet, allowing the SIJ mobilization device (1) of the invention to mobilize the sacral portion of the SIJ complex on the pelvis at the SIJ.

As noted above, these exemplary SI joint mobilization procedures, whether self-initiated or assisted by a care provider may be performed on a prescribed schedule as part of a physical therapy course of treatment overseen by a medical professional. In one preferred embodiment, a subject may perform one or more of the SI joint mobilization procedures for 5-10 minutes, and preferably 3-5 days/week. As also noted above, these exemplary SI joint mobilization procedures may be performed as needed, for example to alleviate chronic or periodic SI joint pain.

As used herein, the term “mobilization” and “joint mobilization” describes a manual technique directed to the subject's joint whereby a clinician or device imparts passive or active movements. Joint mobilization is characterized by low-velocity movements that may relieve pain or improve range of motion by improving joint play and restoring the slide and glide arthrokinematics of the joint, and preferably the SI joint according to this invention.

As used herein, the term “subject” means a human subject that may be in need of SI joint mobilization, may be susceptible to SI joint dysfunction for which SI joint mobilization may provide a positive therapeutic outcome, or a may benefit from SI joint mobilization as a preventative treatment for SI joint dysfunction.

What is claimed is:

1. A sacroiliac joint (SI) joint mobilization device comprising:
a planar base configured to be positioned on a rigid surface;
a pair of opposing longitudinal extensions extending from said planar base, and wherein said opposing longitudinal extensions are established in an angled configuration so as to be positioned within a subject's SIJ complex; and
a sacral pocket having a contact surface formed by said planar base and said opposing longitudinal extensions and configured to be coupled with said subject's sacrum, and wherein said opposing longitudinal extensions are further configured to be tractable in response to a downward force applied by said subject when placed in a supine position with the SI joint mobilization device coupled with said subject's SIJ complex and thereby facilitating mobilization of the subject's SI joint.

2. The device of claim 1, wherein said opposing longitudinal extensions form left and right side walls.

3. The device of claim, wherein said planar base comprises a planar base having a front and back wall.

4. The device of claim, wherein said pair of opposing longitudinal extensions extending from said planar base are coupled with a tractable connection.

5. The device of claim 1, wherein said tractable connection comprises an adjustable mechanical connection.

6. The device of claim 4, wherein said SI joint mobilization device is formed by a tractable material.

7. The device of claim 6, wherein said tractable material comprises a tractable material selected from the group consisting of: plastic, thermoplastic, rubber, silicone, silicone rubber, and a composite material, or a combination of the same.

8. The device of claim 1, wherein said opposing longitudinal extensions are positioned at an angle between 20°-25° degrees from a median center line of said SI joint mobilization device.

9. The device of claim 1, wherein said opposing longitudinal extensions are positioned at an angle of 22° degrees from a median center line of said SI joint mobilization device.

10. The device of claim 1, wherein said opposing longitudinal extensions established in an angled configuration comprises opposing longitudinal extensions established in an angled configuration having a height at, or less than 1 inch.

11. A method of mobilizing the sacroiliac joint (SI) joint in a subject in need thereof comprising the steps of:
establishing a SI joint mobilization device having a planar base configured to be positioned on a rigid surface and a pair of opposing longitudinal extensions extending from said planar base, and wherein said opposing longitudinal extensions are established in an angled configuration to be coupled with a subject's SIJ complex;
placing said opposing longitudinal extensions in between the right and left posterior superior iliac spines within the subject's SIJ complex;
positioning said subject into a supine position on a rigid surface with the opposing longitudinal extensions in between the right and left posterior superior iliac spines within the subject's SIJ complex, such that the subject's sacrum is positioned within a sacral pocket of said SI joint mobilization device, and optionally bending said subject's knees and bringing the bottoms of the subject's feet into a resting position on said rigid surface; and
initiating one, or a series of prescribed motions to engage mobilization of the subject's SI joint.

12. The method of claim 11, wherein said SI joint mobilization device comprises the SI joint mobilization device of claim 1.

13. The method of claim 11, wherein said the prescribed motions comprise a series of controlled back-and-forth movements of said subject's knees allowing the SIJ mobilization device to mobilize the pelvic portion of the SIJ complex on the sacrum at the SIJ.

14. The method of claim 11, wherein said prescribed motions comprises a series of controlled pelvic tilts towards said subject's head followed by one, or a series of controlled pelvic tilts towards said subject's feet, allowing the SIJ mobilization device to mobilize the sacral portion of the SIJ complex on the pelvis at the SIJ.

15. The method of claim 11, wherein said the prescribed motions comprises maintaining the subject's supine position and allowing the weight of the subject's own pelvic complex to downwardly press against said SIJ mobilization device allowing SI joint mobilization.

16. The method of claim 11, wherein said the prescribed motions are initiated by the subject.

17. The method of claim 11, wherein said the prescribed motions are initiated by a care provider or medical professional.

18. The method of claim 11, wherein said method is executed as needed to control a subject's SI joint pain.

19. The method of claim 11, wherein said method is executed pursuant to a medically prescribed regime established to treat SI joint dysfunction.

20. The method of claim 11, wherein the prescribed motions are executed for at least 10 minutes, and optionally 3-5 times a week.
